(19) United States
(12) Patent Application Publication
(10) Pub. No.: US 2020/0050649 A1
(43) Pub. Date: Feb. 13, 2020

(54) Method for identifying discrete urysohn models

(71) Applicants: Andrew Polar, Duluth, GA (US); Michael Poluektov, Coventry (GB)

(72) Inventors: Andrew Polar, Duluth, GA (US); Michael Poluektov, Coventry (GB)

(21) Appl. No.: 15/998,381

(22) Filed: Aug. 11, 2018

(51) Int. Cl. G06F 17/16; G06F 17/11

(52) U.S. Cl. CPC G06F 17/16; G06F 17/11

(57) ABSTRACT

A computationally inexpensive and stable method for real-time identification of nonlinear objects of the Urysohn type conducted by applying a model improvement steps for every set of recorded instantaneous input and output values.

### CROSS-REFERENCES TO RELATED APPLICATIONS

Not Applicable

### FEDERALLY SPONSORED RESEARCH OR DEVELOPMENT

Not Applicable

### SEQUENCE LISTING OR A COMPUTER PROGRAM

Not Applicable

### BACKGROUND OF INVENTION

### Field of Invention

This invention relates to modeling dynamic nonlinear control systems and model identification by processing input and output data as discrete time readings from sensors. From all variety of nonlinear systems, this invention is only relevant for deterministic, stationary objects of the Urysohn type with multiple inputs.

### FIGS. 1-5—Prior Art

Objects of the Urysohn type have certain counterintuitive properties, which must be discussed in details. Therefore, we start an explanation of the prior art using an illustrative example and provide generalization below. The considered object of the Urysohn type with input g and output r is shown in FIG. 1. The precise model of the object is shown in FIG. 2. The model converts input g into output r via an integral operator with kernel U. This kernel U is a continuous function of two variables. The integral operator uniquely defines the object and, in the considered case, it is the model of the object. Such continuous models are usually used in theoretical descriptions, while in engineering practice, discrete models are often employed. When recordings of input and output are conducted by a digital measurement equipment, input and output represent discrete time series with quantized and approximately known values. The quantization is a result of analog-digital conversion, while the inaccuracy in values results from an external noise. To address discretization and quantization of the model, we need to transform the continuous model, shown in FIG. 2, into a discrete one, which is shown in FIG. 3. Kernel U becomes matrix M. Arguments x(m−j) and j are natural numbers and represent the positions of elements of matrix M. Representation of input x by natural numbers is always possible because quantized input, recorded by digital equipment, takes the finite set of values, therefore, it is always possible to construct a mapping from recorded quantized input to natural numbers.

For explanatory purposes, it is useful to give an illustrative example how the discrete Urysohn operator works. Since the discrete Urysohn operator is fully defined by matrix M, as shown in FIG. 3, in order to demonstrate the machinery of the operator, we assign arbitrary matrix elements, which are shown in FIG. 4. Such small size is chosen for convenience of the explanation. Let index j be a column and value of x be a row. Assume that we need to calculate z at a certain moment of time, which corresponds to index m, while x(m)=3, x(m−1)=2 and x(m−2)=3. In this case, value z(m) is calculated by summation of particularly selected elements of the matrix, as shown in FIG. 4 in bold font.

The model of a real object may only be larger in size but operates in the same way. When approximated by the discrete Urysohn model, large class of inertial objects with moving parts, such as engines, vehicles, boats, planes, lead to a model matrix with certain properties. For such objects, a small variation of input always causes a small variation of output. It is possible only if adjacent elements of the matrix differ insignificantly compared to remote ones. The identification problem of a Urysohn-type object in the discrete case is an estimation of elements of the matrix, provided plurality of partial sums of matrix elements.

After we described the model, the prior art can be introduced. The first and only known to authors method of identification of the Urysohn operator as a matrix for discrete and quantized inputs, which are positions of elements of this matrix, is provided in Ph.D. thesis of one of the authors of this invention (A. R. Poluektov, 1990). The proposed method was valid only for objects with one input. Since each output value results from a certain input sequence, the idea was to stretch the elements of unknown matrix M into vector-column V and convert each input sequence into vector-column P of the same size with elements equal to 0 or 1. Non-zero elements of vector-column P must be arranged in such way, that inner product (V,P) selects and adds the same elements that would be selected from matrix M and summed. This idea is illustrated in FIG. 5. The matrix is stretched into vector-column V using the zigzag pattern. Vector-column P is shown below. It has only three elements equal to 1, to provide the summation of correctly chosen elements when inner product (V,P) is computed. In Ph.D. thesis (A. R. Poluektov, 1990), to find elements of matrix M, it was suggested to assemble and solve the linear system of equations, where each equation corresponds to the particular output value being equal to the inner product of V and corresponding P. Rearranging elements of the matrix using the zigzag pattern provides “smoothness” of the expected solution, as the Urysohn matrix is expected to be “smooth”. Here term “smooth” is not used in strict mathematical sense, but implies closeness of the values of the neighboring matrix elements. Furthermore, to solve the linear system, the regularization technique was applied. It was demonstrated that such approach is viable, although is exposed to the following problems: a) the system of linear algebraic equations is extremely large for real-world systems; b) it was proven that independently of input/output data, the linear system is always degenerate, i.e. there are infinitely many solutions of the problem; c) as already mentioned, this approach was developed and tested for objects with only one input. The Urysohn objects with multiple inputs were not considered.

We can also mention methods of (L. V. Makarov, 1994) and (P. G. Gallman, 1975). They fall under the same category of computational complexity. It is possible to identify the model parameters, however, it may require a human intervention into data processing with changes of logic, which requires exclusive expert knowledge in multiple fields, such as computational algorithms of linear algebra and theory of integral operators. Unfortunately, such algorithms are barely suitable for implementation in a microchip mounted on a physical object and for processing the sensor readings.

The Hammerstein model is the closest model to the Urysohn model, which is a particular case of Urysohn. It has two sequentially connected blocks: a nonlinear static block and a linear dynamic block. The major difference between the Hammerstein and the Urysohn models is the linearity of dynamic part of the Hammerstein model, as opposed to nonlinear dynamic part of the Urysohn model. We can mention publicly available methods for identification of Hammerstein objects (e.g. U.S. Pat. No. 8,260,732 to Al-Duwaish, 2012, J. M. M. Anderson, 1994, E. W. Bai and D. Li, 2004). These methods cannot be used for identification of an Urysohn model, as it has significant differences. However, the reverse is possible—the Urysohn model can be used instead of the Hammerstein model without any changes and can even be simplified, i.e. reduced in size, if the object, for which the Urysohn model is constructed, happens to be of the Hammerstein type. Being more specific, if identified Urysohn matrix can be expressed as an outer product of two vectors, i.e. approximated by a matrix of rank equal to one, the Urysohn model becomes the Hammerstein model.

### Objects and Advantages

This invention offers a computationally stable method for identification of nonlinear objects of the Urysohn type with multiple inputs, designed to calculate model parameters by automatic processing of sensors' readings in real time during regular operation of the object. The computation is conducted as successive alterations of model parameters. The advantages introduced by this invention are:

a) the method is applicable to Urysohn objects with multiple inputs in the same way as for single input objects;

b) it is computationally inexpensive, stable and robust with respect to data errors;

c) it requires a small number of computational operations at each model improvement step, such that the parameters can be identified in real-time;

d) it does not require solving large system of linear algebraic equation with poorly conditioned or degenerate matrix;

f) in the case when identification is repeated multiple times for different datasets but for the same object, the obtained models converge to the same result.

### BRIEF SUMMARY OF INVENTION

This invention provides a method of identifying the discrete Urysohn model with multiple inputs by elementary sequential computational steps using recorded input and output values. The method is applicable for real-time identification. The result is achieved by modification of specifically selected model parameters each time new set of measured values is obtained. Parameter selection depends on the input values.

### BRIEF DESCRIPTION OF SEVERAL VIEWS OF THE DRAWINGS

FIG. 1 shows the considered dynamic object and introduces notations for input and output.

FIG. 2 shows the continuous Urysohn model of the object defined in FIG. 1.

FIG. 3 shows the discrete Urysohn model in the case of integer arguments x and j.

FIG. 4 shows an example of an application of the rule of element selection for computing output value z, having integer arguments x and j.

FIG. 5 shows an example of computing an output value using vector-column V, obtained by rearranging matrix elements, and auxiliary vector-column P with binary elements.

FIG. 6 shows the continuous Urysohn model of the object with two inputs.

FIG. 7 shows the discrete Urysohn model of the object with two inputs.

FIG. 8 shows an example of an application of the rule of selection of matrix elements for computing an output value in the case of two inputs.

FIG. 9 shows the idea behind the projection descent method.

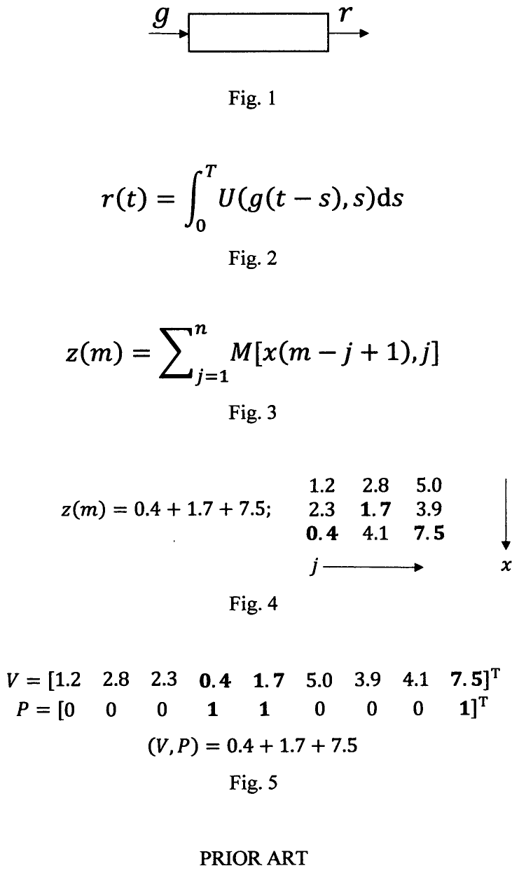

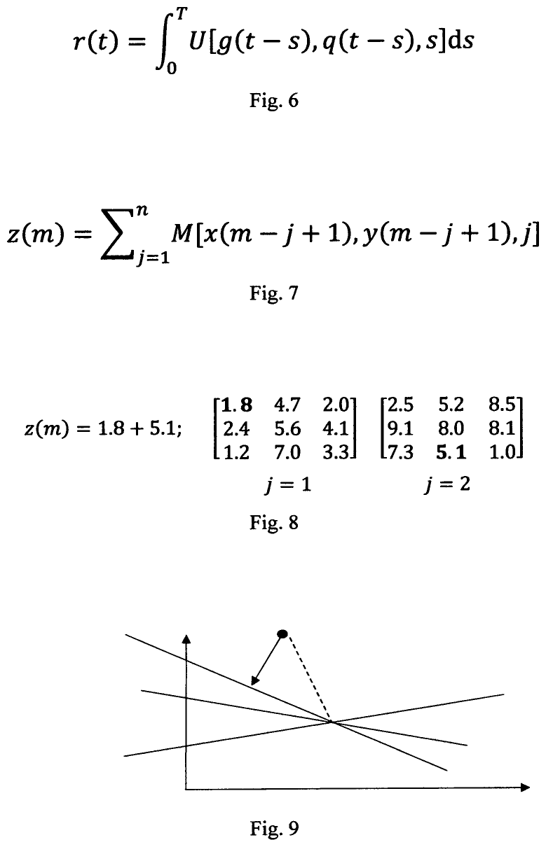

### DETAILED DESCRIPTION—FIGS. 6-9—PREFERRED EMBODIMENT

The first difference between the prior art method (A. R. Poluektov, 1990) and this invention is the generalization of the discrete model for the case of multiple inputs. The continuous model for the case of two inputs, g and q, is shown in FIG. 6. Kernel U becomes a function of three variables. For the case of discrete and quantized inputs and integer arguments, the continuous model is transformed into a discrete one shown in FIG. 7. Here, two-input case is used for the simplicity of the explanation and demonstrates the structure of a multiple-input model. The one-input discrete Uryshon model is a two-dimensional (2D) matrix with specific rule of input-output transformation, while the two-input model is three-dimensional (3D) matrix. The position of an element in this 3D matrix is uniquely determined by two integer arguments x and y and time index j. An illustrative example demonstrating the operation of the model is provided in FIG. 8. Since matrix is 3D, we can only show its layers. Index j denotes the time moment, therefore we can say that matrices in FIG. 8 are time layers. In FIG. 8, an example of a choice of elements in these layers, which are involved in computation of output value z(m), is shown in bold font, given x(m)=1, y(m)=1, x(m−1)=3, y(m−1)=2. Only one element is selected in each time layer for computation of the output. In the case when the number of inputs is greater than two, there is the same number of time layers as inputs and the output is computed by adding a single element from each layer. The position of this single element in each layer is determined by integer arguments, which are inputs. For the case of one input, considered in prior art, this time layer is a one-dimensional matrix i.e. a column.

Similar to the prior art method, we can stretch the set of time layer matrices into single vector-column V and introduce auxiliary vector-column P with elements equal to zero or one. Obviously, non-zero elements in vector P must be arranged in such a way that inner product (V,P) selects and adds matrix elements involved in computation of output z(m).

When real objects are approximated using the Urysohn model, the matrix sizes are significantly larger than the example in FIG. 8. If we assemble a system of linear algebraic equations using auxiliary vectors P for a real object, the size of the system will not allow solving the identification problem efficiently. As already stated in the prior art, such matrix is always degenerate, independently of data and, more importantly, its rank is significantly smaller than its size. The problem of estimation of elements of the model matrix is solved by the second novelty introduced in this invention —application of the projection descent method (S. Kaczmarz, 1937) for gradual tuning of the model for each set of new sensors' reading. The idea behind the projection descent method is shown in FIG. 9. The picture shows three lines intersecting at a single point. If we express these three lines as linear dependencies, we will obtain the system of linear equations and the coordinates of the intersection point is the solution. When an arbitrary point is taken and the projection of this point to any of these lines is found, a right triangle is formed. The distance from the point to the solution equals to hypotenuse length, while the distance from its projection to the solution equals to cathetus length, therefore, it is shorter and such projection step brings point closer to the solution. By keeping projecting this point iteratively from one line to another in any order, we will reach the solution. Obviously, it works for hyperplanes in multidimensional spaces in the similar way. We can emphasize here several important properties of the projection descent: a) we do not need to know the entire system of linear algebraic equations, we can apply it line by line, and if data is delivered by sensors, we can apply it concurrently with readings; b) if the angle between lines is small the convergence is slow, but if lines are close to being orthogonal, the convergence is fast; c) it has been proven that in the case of infinitely many solutions, the method converges to a solution with the minimum norm (sum of squares), if initial approximation is the origin (all zero components).

An application of the projection descent method for the case of sparse matrix with non-zero elements being equal to one is much simpler compared to a generic case. Taking any model matrix M as an intermediate result, we need to compute the difference between the modelled output and an actual output, divide this difference by the number of involved elements and add this divided difference to each element of this 3D matrix, which was involved in the computation of the above difference. This model adjustment step can be explained using example in FIG. 8. We can see that two elements 1.8 and 5.1 are selected for computation of the output, which is 1.8+5.1=6.9. Assume that our measurement system recorded actual value of 7.9. In this case, we subtract modelled value of 6.9 from actual value of 7.9, divide the difference by two (because of two elements) and add this divided difference 0.5 to each involved element, i.e. modify 1.8 into 2.3 and 5.1 into 5.6. By repeating this elementary correction for each new reading, we will converge to an accurate matrix. The method converges for any initial approximation, but in order to obtain result with the minimum norm, the initial approximation must be an all-zero solution. No auxiliary vector-columns P are created; these vector-columns were introduced only for explanation. Moreover, no actual rearrangement of matrix elements into a vector-column is necessary. The matrix elements are modified at each step directly. The prior art method (A. R. Poluektov, 1990) required building a large sparse matrix from plurality of auxiliary vectors-columns P and numerically solving the system. Direct modification of matrix elements is the distinct difference of this method from the prior art method. Quick convergence of the projection descent method results from majority of vectors P being almost pairwise orthogonal, as each new iteration involves shifts of the input sequence, thus shifts of ones in vector P. We can tell when matrix converges by reductions in differences, which are computed at each step. The obtained solution is unique and has minimum norm. The inaccuracies in measured inputs x and y formally lead to correction of wrong elements. When error is small, these elements are neighboring to correct elements, and, since the matrix is “smooth”, the values are close. In the long run, these errors have tendency to cancelling each other rather than accumulating. For stability and error filtering it is recommended to use regularization, i.e. a positive multiplier that reduces the difference with value smaller than 1.0. The smaller value is for noisier data.

For better understanding of every little detail of the suggested method, the authors provided publicly available DEMO (http://ezcodesample.com/urysohn/urysohn.html, 2018). It is a computer program that generates two different implementations of inputs and outputs for the same Urysohn operator, conducts an identification for both implementations and shows that models obtained from two different implementations are accurate and identical. In addition to this, the authors describe mathematical details of the proposed method in scientific paper (M. Poluektov and A. Polar, 2018).

### DESCRIPION—ALTERNATIVE EMBODIMENT

When identification is conducted as a real-time process by an automatic system, we expect inputs to be random. This means that sometimes not all values of model matrix M can be identified. For example, assume that input x is given by a temperature sensor, which records integers from range [1,100]. During the identification procedure, the temperature did not vary in the entire range, and x took values between 21 and 49. In this case, the edge elements of matrix M are not determined. The obvious solution is to extrapolate M, assuming “smoothness”. The less obvious solution is to factor M into a product of two matrices (it is possible even with missing elements), then multiply cofactors and obtain the missing values. However, neither of these is required of the operation of the Urysohn model and partially known model M can be used as is. This is the unique feature available for dynamic models in the form of nonlinear integral equations. Such model can be used even when it is known partially, which is not possible for models in the form of differential equations, neither for linear dynamic models. If we identified the model using range [21,49] of input x, we can compute an output for an input from this range. When x takes a value outside this range, the output is unknown, however, when it comes back to this range, the output again becomes computable.

Here is one example when we need this strange partially known model for computing fragmented output. Assume we have built a microprocessor system for diagnostics of a dynamic Urysohn-type object. After we identified the model, we can predict output having the model and measured input. If the physical object has changed its dynamic properties, the computed output will not match recorded one. Having ability to compute fragments of an output signal is sufficient for diagnostic purposes. Although the model is partially known and not all outputs can be computed, those are that computed are accurate.

### REFERENCES

S. Kaczmarz. Angenaherte Auflosung von Systemen linearer Gleichungen. Bulletin International de l'Académie Polonaise des Sciences et des Lettres. Classe des Sciences Mathematigues et Naturelles. Serie A, Sciences Mathematigues, 35: pp. 355-357, 1937.
J. M. M. Anderson. Nonlinear system identification using a Hammerstein model and a cumulant-based Steiglitz-McBride algorithm. In IEEE International Conference on Acoustics, Speech and Signal Processing, 429-432, 1994.
E. W. Bai and D. Li. Convergence of the iterative Hammerstein system identification algorithm. IEEE Transactions on Automatic Control, 49(11):1929-1940, 2004.
M. Poluektov and A. Polar. Modelling of Non-linear Control Systems using the Discrete Urysohn Operator. Published online at arxiv.org, arXiv: 1802.01700, Feb. 5, 2018.
A. R. Poluektov. Development of automatic methods for identification of diesel engines as objects of automatic control and diagnostics. PhD dissertation, Leningrad State Technical University, 1990. In Russian.
L. V. Makarov. An Interpolation Method for the Solution of Identification Problems for a Multidimensional Functional System Described by a Urysohn Operator. Journal of Mathematical Sciences, 70(1):1508-1512, 1994.
P. G. Gallman. Iterative method for identification of nonlinear systems using a Uryson model. IEEE Transactions on Automatic Control, 20(6):771-775, 1975.
A. Polar. Multidimensional Integral Operator of Urysohn Type. Online at http://ezcodesample.com/urysohn/urysohn.html. February, 2018.
U.S. Pat. No. 8,260,732. Method for identifying of Hammerstein models. To Al-Duwaish. 2012.

We claim:

1. A method for identification discrete Urysohn models with multiple inputs taking integer values, comprising the steps of:
(a) providing a recorded output value and sequences of integer input values,
(b) use said integer input values along with time indices as positions of elements of a multidimensional matrix, representing said Urysohn model, for
(c) computing a difference between said recorded output value and a sum of all said involved matrix elements and
(d) correcting all said involved matrix elements by adding to each of them a value that reduces said difference between said recorded output value and said sum of involved elements and
(e) repeating steps (b) through (d) for a plurality of available data, that are sequences of said input and said output values until said computed difference (c) falls into expected range.

2. Selection of said elements of said multidimensional matrix of claim 1 for computing of said difference, wherein each said time index holds a layer of said matrix and each said integer input is equal to an index of said matrix element in the direction, orthogonal to all other inputs.
